(19) United States
(12) Patent Application Publication
(10) Pub. No.: US 2002/0104446 A1
(43) Pub. Date: Aug. 8, 2002

(54) Axial-flow squeezing apparatus

(76) Inventor: Koichi Arai, Kanagawa-ken (JP)

Correspondence Address: CARELLA, BYRNE, BAIN, GILFILLAN, CECCHI,, STEWART & OLSTEIN, 6 Becker Farm Road, Roseland, NJ, 07068, US

(21) Appl. No.: 10/047,273

(22) Filed: Oct. 23, 2001

(30) Foreign Application Priority Data
Oct. 27, 2000 (JP) 2000-328895

(51) Int. Cl. A23N 1/00

(52) U.S. Cl. 99/495

(57) ABSTRACT

The objective of the present invention is to provide an axial-flow squeezing apparatus capable of increasing operating duration, operating efficiency and production efficiency of the axial-flow squeezing apparatus by avoiding clogging phenomena by forming communicating portions. The axial-flow squeezing apparatus having the following arrangements attains the objective of the present invention. A spirally formed revolving blade around an axis comprising a spiral base of said blade, a spiral surface and spiral boundaries formed between said spiral base and said spiral surface; and communicating portions formed at said spiral surface and/or said boundaries on desired bored portions of the latter half of said axis for forming bypath channels so as to enable to avoid clogging during squeezing operations.

### BACKGROUND OF THE INVENTION

1. Field of the Invention

The present invention relates to an axial-flow squeezing apparatus employed in food processing industries, environment controlling industries and the like.

2. Brief Description of Related Art

In an axial-flow squeezing apparatus where an axis equipped with a revolving blade, is rotated in a barrel, and a squeezing process is executed by a transferring pressure generated by the rotating movement of the axis, usually solid-liquid separating processes such as separating animal or vegetable oil, squeezing fruit juice, dehydrating fish/livestock meat or sludge or the like, are executed by raking objects to be processed between spirally arranged continuous blade and the axis.

However, in the above-mentioned conventional axial-flow squeezing apparatuses, clogging phenomena occur during operations owing to properties of objects to be processed. Which lead to troubles in the apparatuses in some cases

### SUMMARY OF THE INVENTION

The present invention is carried out in view of the above-mentioned problems in order to provide an axial-flow squeezing apparatus capable of eliminating clogging phenomena during squeezing operations by arranging bypath channels comprising communicating portion such as grooves at desired portion of an axis equipped with blade or desired base portions of blade. The above-mentioned problems are solved by the following constitutions according to the present invention.

(1) An axial-flow squeezing apparatus for continuous solid-liquid separation of objects to be squeezed comprising: a perforated outer element formed into a cylindrical or conical shape; and a spirally formed revolving blade around an axis comprising a spiral base of the blade, a spiral surface and spiral boundaries formed between the spiral base and the spiral surface; where: communicating portions are arranged at the spiral surface and/or the boundaries on desired portions of the latter half of the axis for forming bypath channels so as to enable to avoid clogging during squeezing operations.

(2) An axial-flow squeezing apparatus for continuous solid-liquid separation of objects to be squeezed comprising: a perforated outer element formed into a cylindrical or conical shape; and a spirally formed revolving blade around an axis comprising a spiral base of the blade, a spiral surface and spiral boundaries formed between the spiral base and the spiral surface; where: cutouts are formed so as to be communicated to the spiral surface and the spiral boundaries at a desired portions of the latter half of the axis; and one or not less than two communicating grooves are arranged along the cutouts for forming bypath channels so as to enable to avoid clogging during squeezing operations.

(3) An axial-flow squeezing apparatus for continuous solid-liquid separation of objects to be squeezed comprising: a perforated outer element formed into a cylindrical or conical shape; and a spirally formed revolving blade around an axis comprising a spiral base of the blade, a spiral surface and spiral boundaries formed between the spiral base and the spiral surface; where: the latter half of the axis is bored cylindrically up to a desired position; cutouts are formed so as to be communicated to the spiral surface and the spiral boundaries; an inner sleeve having one or not less than two communicating portions is inserted and fitted in the cylindrical bore so that the communicating portions are arranged along said cutouts for forming bypath channels so as to enable to avoid clogging during squeezing operations.

(4) An axial-flow squeezing apparatus for continuous solid-liquid separation of objects to be squeezed comprising: a perforated outer element formed into a cylindrical or conical shape; and a spirally formed revolving blade around an axis comprising a spiral base of the blade, a spiral surface and spiral boundaries formed between the spiral base and the spiral surface; where: almost all of the axis except starting portion of the squeezing is bored cylindrically up to a desired position; cutouts are formed so as to be communicated to the spiral surface and spiral boundaries; an inner sleeve having one or not less than two communicating portions is inserted and fitted in the cylindrical bore so that the communicating portions are arranged along the cutouts for forming bypath channels so as to enable to avoid clogging during squeezing operations.

(5) The axial-flow squeezing apparatus according to either one of (1) to (4), where: the communicating portions are straightly extending grooves along the surface and the center of the axis.

(6) The axial-flow squeezing apparatus according to either one of (1) to (4), where: the communicating portions are diagonally extending grooves against the surface and the center of the axis.

(7) The axial-flow squeezing apparatus according to either one of (1) to (4), wherein: the axis is formed in a columnar shape; and the revolving spiral blade is wound around the axis evenly or unevenly; where: the height of the blade is gradually decreasing in the squeezing direction so that the tip portion of the blade forms a conical shape, of which diameter is gradually decreasing in the squeezing direction.

(8) The axial-flow squeezing apparatus according to either one of (1) to (4), wherein: the axis is formed in a conical shape, of which diameter is increasing in the squeezing direction; and the revolving spiral blade is wound around the conical axis evenly or unevenly; where: the height of said blade is arranged so that the tip portion of the blade forms a cylindrical shape.

(9) The axial-flow squeezing apparatus according to either one of (1) to (4), where: the axis is formed in a conical shape, of which diameter is gradually decreasing in the squeezing direction; and the revolving spiral blade is wound around said the evenly or unevenly; where: the height at any portion of the blade is set at equal so that the tip portion of the blade forms a conical shape, of which diameter is gradually decreasing in the squeezing direction.

(10) The axial-flow squeezing apparatus according to either one of (1) to (4), where: the axis is formed in a columnar shape; the revolving spiral blade is wound around the axis evenly or unevenly; and the height at any portion of the blade is set equal so that the tip portion of the blade is formed in a cylindrical shape.

### BRIEF DESCRIPTION OF DRAWINGS

FIG. 1 shows drawings for explaining arrangements of revolving blade of the axial-flow squeezing apparatus with a half-long inner sleeve according to the present invention: (a) is a front view of the apparatus; (b) is a side view of the apparatus where the revolving blade is spirally formed gradually decreasing its pitch in a squeezing direction; (c) is a front view of the inner sleeve; (d) shows straightly formed bypath grooves on the inner sleeve and (e) shows diagonally formed bypath grooves on the inner sleeve.

FIG. 2 is a cross-sectional view of an axial-flow squeezing apparatus where outer diameter decreasing in the squeezing direction formed in a conical shape, the revolving blade is spirally formed by the same pitch but the height of blade is gradually decreasing in the squeezing direction and bypath channels on the inner sleeve are formed straightly.

FIG. 3 is a cross-sectional view of an axial-flow squeezing apparatus where outer diameter of the apparatus and its axis are decreasing in a squeezing direction formed in a conical shape, the revolving blade is spirally formed by the same pitch and the height of the blade is formed equally in the squeezing direction and bypath channels on the inner sleeve are formed straightly.

FIG. 4 is a cross-sectional view of an axial-flow squeezing apparatus where outer diameter has a cylindrical shape and its axis has a conical shape increasing its diameter in a squeezing direction, the revolving blade is formed by the same pitch but the height of blade is gradually decreasing in the squeezing direction and bypath channels on the inner sleeve are formed straightly.

FIG. 5 is a perspective view of the other embodiment.

FIG. 6 shows drawings for explaining arrangements of revolving blade of the axial-flow squeezing apparatus with an almost full-long inner sleeve according to the present invention: (a) is a front view of the apparatus; (b) is a side view of the apparatus where the revolving blade is spirally formed gradually decreasing its pitch in a squeezing direction; (c) is a front view of the inner sleeve; (d) shows straightly formed bypath grooves on the inner sleeve and (e) shows diagonally formed bypath grooves on the inner sleeve.

### DETAILED DESCRIPTION OF THE PREFERRED EMBODIMENTS

Hereinafter embodiments according to the present invention are explained by referring to drawings.

The main portions of axial-flow squeezing apparatuses shown in these drawings have the following common components: a perforated outer element EL made of a wire-slit element, a punching metal, net, a porous material and the like which bear slit holes, formed into a cylindrical or conical shape; a spirally formed revolving blade 1 around an axis 2 comprising a spiral base of the blade, a spiral surface 3 and spiral boundaries 4 between the spiral base and the spiral surface 3; communicating portions are formed at the spiral surface 3 and/or spiral boundaries 4; Cutouts 6 partially formed at a latter half of the axis 2 communicating to the spiral surface 3 and spiral boundaries 4 at a desired bored portions of the axis 2; one or not less than two communicating channels formed along cutouts 6 acting as bypaths channels i.e. clearance grooves. Alternatively the following arrangement may be employed: a bore formed at the latter half of the axis 2; the spirally formed revolving blade 1 around an axis 2 comprising a spiral base of the blade, a spiral surface 3 and spiral boundaries 4 between the spiral base and the spiral surface 3; cutouts 6 communicating to the spiral surface 3 and spiral boundaries 4; an inner sleeve IS having one or not less than two communicating grooves 5a or 5b, inserted and fitted in the bore formed at the latter half of the axis 2 where the communicating grooves 5a or 5b as bypath channels formed on the inner sleeve IS prevent clogging phenomena during squeezing operations.

One or not less than two communicating grooves 5a or 5b are formed parallel along the surface and the center of the axis 2 (straight grooves 5a) or formed diagonally along the surface and the center of the axis (diagonal grooves 5b).

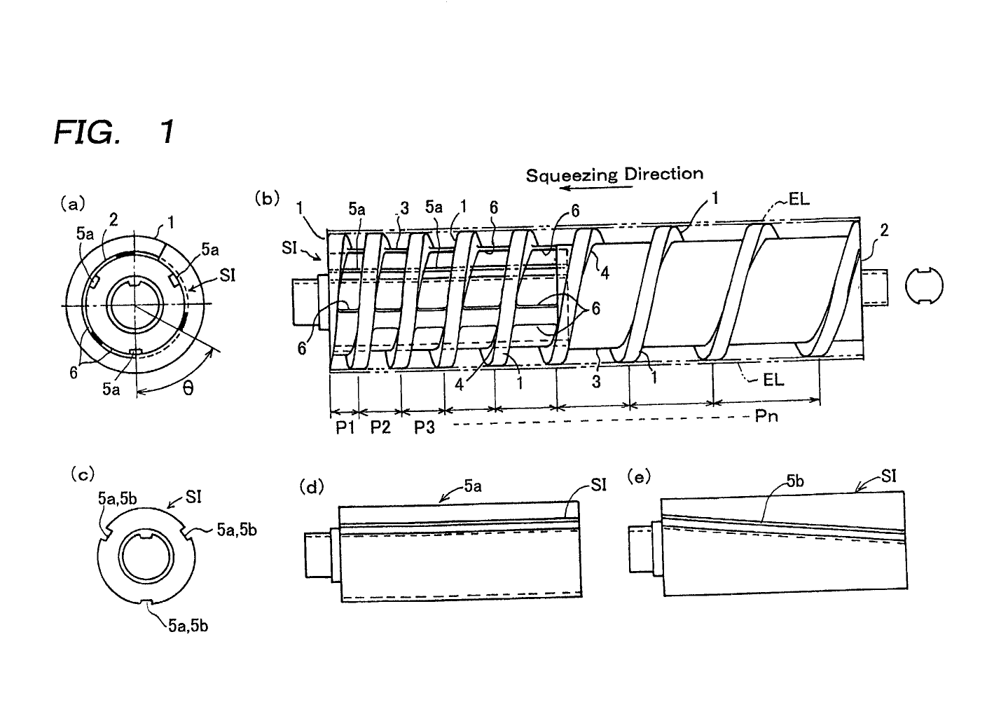

In FIG. 1 the main portion of the axial-flow squeezing apparatus is arranged as follows. The axis 2 is formed in cylindrical or columnar shape. The revolving spiral blade 1 is wound around axis 2 unevenly where wound pitches Pn . . . P₃, P₂, P₁ are decreasing in the squeezing direction as shown in (b) of the FIG. 1, but the height of the blade 1 is set equal.

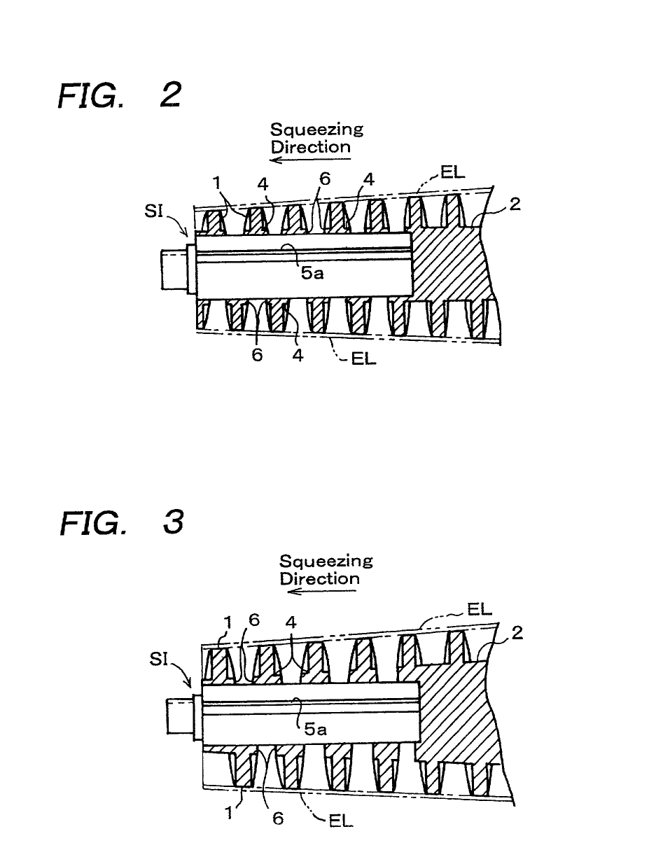

In FIG. 2 the main portion of the axial-flow squeezing apparatus is arranged as follows. The axis 2 is formed in columnar shape. The revolving spiral blade 1 is wound around axis 2 evenly or unevenly, where height of the blade is gradually decreasing in the squeezing direction so that the tip portion of the blade forms a conical shape.

In FIG. 3 the main portion of the axial-flow squeezing apparatus is arranged as follows. The axis 2 is formed in conical shape of which diameter is decreasing in the squeezing direction. The revolving spiral blade 1 is wound around the conical axis 2 evenly or unevenly, where height of the blade is set equal, but the tip portion of the blade forms a conical shape of which diameter is decreasing in the squeezing direction.

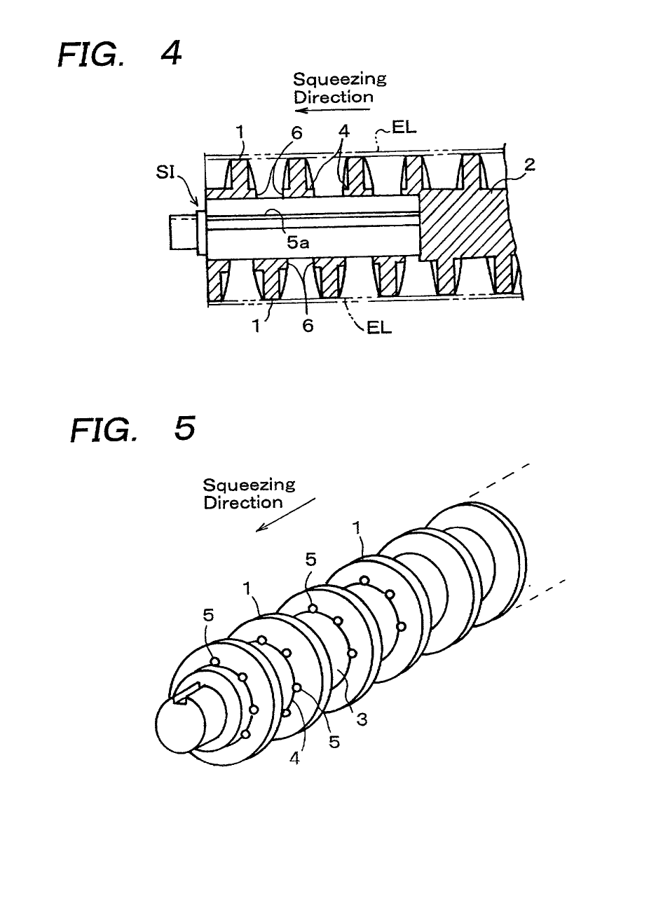

In FIG. 4 the main portion of the axial-flow squeezing apparatus is arranged as follows. The axis 2 is formed in conical shape of which diameter is gradually increasing. The revolving spiral blade 1 is wound around axis 2 evenly or unevenly, where the tip portion of the blade forms a columnar shape.

FIG. 5 depict other different embodiment where communicating portions 5 are formed by boring along the spiral boundaries 4 so as to be capable of avoiding clogging during squeezing operations.

Communicating portions 5 forming bypath channels may be directory formed along the boundaries 4 without employing the inner sleeve IS. The number and the size of the communicating portions 5 are determined in accordance with properties of objects to be squeezed and squeezing statuses. Alternatively, straight grooves 5a or diagonal grooves 5b on the inner sleeve IS may also employed in accordance with properties of objects to be squeezed and squeezing statuses.

As shown in (a) and (b) in FIG. 1, for example, up to 60 degrees rotated from the squeezing end of the axis 2, cutouts 6 are not formed. In these figures, three cutouts 6 are evenly formed in a radial direction of the axis 2, but the number and positions of cutouts 6 may be selected freely taking structural features of the apparatus such as a strength and properties of objects to be squeezed into consideration.

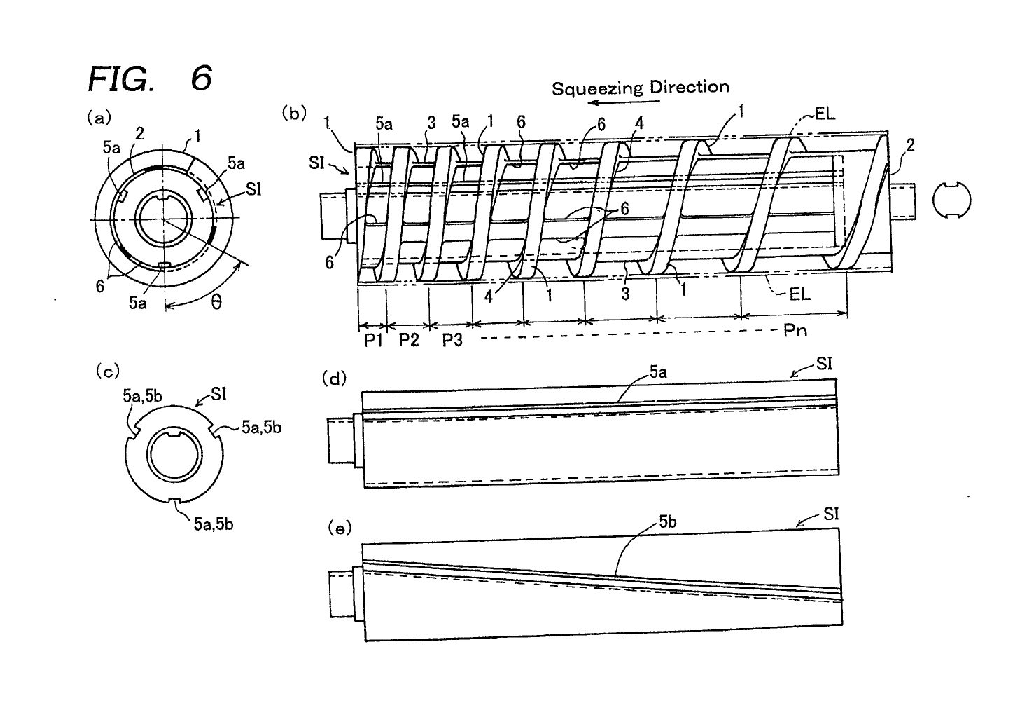

In stead of the arrangement shown in FIG. 1, an arrangement shown in FIG. 6 can be also employed as an axial-flow squeezing apparatus where almost all portions of the axis 2 except a starting portion of the squeezing are bored. This arrangement is suitable for objets to be treated which tends to cause clogging phenomena. Since except the bored length and the length of the corresponding inner sleeve IS, other arrangements are similar to those shown in FIG. 1, further explanation is omitted.

Hereinafter effects of the present invention based on constitutions mentioned above are explained.

These constitutions are arranged so as to avoid clogging phenomena during squeezing operations such as filtering, separating, dehydrating, recovering, concentrating operations and the like by transferring objects to be squeezed by rotating operations of the axis 2 placed in the outer element EL.

The axial-flow squeezing apparatuses according to the present invention can be operated continuously in extracting, mixing, filtering, separating processes and the like for processing food such as tea leaves, coffee or flavoring extract.

Clogging phenomena caused by coagulation and the like during wastewater treatments are avoided by bypath channels formed by communicating portions playing as clearance grooves.

Scrapers can be attached to the tip portions of the continuously and spirally formed blade in accordance with properties of objects to be squeezed.

As explained above, the present invention can increase operating duration, operating efficiency and production efficiency of the axial-flow squeezing apparatus by avoiding clogging phenomena by forming communicating portions 5 properly.

According to the present invention the following effects to increase operating duration, operating efficiency and production efficiency of the axial-flow squeezing apparatus are attained by avoiding clogging phenomena by forming communicating portions 5 properly.

What is claimed is:

1. An axial-flow squeezing apparatus for continuous solid-liquid separation of objects to be squeezed comprising:
a perforated outer element formed into a cylindrical or conical shape; and
a spirally formed revolving blade around an axis comprising a spiral base of said blade, a spiral surface and spiral boundaries formed between said spiral base and said spiral surface; wherein:
communicating portions are arranged at said spiral surface and/or said boundaries on desired portions of the latter half of said axis for forming bypath channels so as to enable to avoid clogging during squeezing operations.

2. An axial-flow squeezing apparatus for continuous solid-liquid separation of objects to be squeezed comprising:
a perforated outer element formed into a cylindrical or conical shape; and
a spirally formed revolving blade around an axis comprising a spiral base of said blade, a spiral surface and spiral boundaries formed between said spiral base and said spiral surface; wherein:
cutouts are formed so as to be communicated to said spiral surface and said spiral boundaries at a desired portions of the latter half of said axis; and
one or not less than two communicating grooves are arranged along said cutouts for forming bypath channels so as to enable to avoid clogging during squeezing operations.

3. An axial-flow squeezing apparatus for continuous solid-liquid separation of objects to be squeezed comprising:
a perforated outer element formed into a cylindrical or conical shape; and
a spirally formed revolving blade around an axis comprising a spiral base of said blade, a spiral surface and spiral boundaries formed between said spiral base and said spiral surface; wherein:
the latter half of said axis is bored cylindrically up to a desired position;
cutouts are formed so as to be communicated to said spiral surface and said spiral boundaries;
an inner sleeve having one or not less than two communicating portions is inserted and fitted in said cylindrical bore so that said communicating portions are arranged along said cutouts for forming bypath channels so as to enable to avoid clogging during squeezing operations.

4. The axial-flow squeezing apparatus according to either one of claims 1, 2, 3 and 10, wherein said communicating portions are straightly extending grooves along the surface and the center of said axis.

5. The axial-flow squeezing apparatus according to either one of claims 1, 2, 3 and 10, wherein: said communicating portions are diagonally extending grooves against the surface and the center of said axis.

6. The axial-flow squeezing apparatus according to either one of claims 1, 2, 3 and 10, wherein:
said axis is formed in a columnar shape; and
said revolving spiral blade is wound around said axis evenly or unevenly; wherein:
the height of said blade is gradually decreasing in the squeezing direction so that the tip portion of said blade forms a conical shape, of which diameter is gradually decreasing in the squeezing direction.

7. The axial-flow squeezing apparatus according to either one of claims 1, 2, 3 and 10, wherein:
said axis is formed in a conical shape, of which diameter is increasing in the squeezing direction; and
said revolving spiral blade is wound around said conical axis evenly or unevenly; wherein:
the height of said blade is arranged so that the tip portion of said blade forms a cylindrical shape.

8. The axial-flow squeezing apparatus according to either one of claims 1, 2, 3 and 10, wherein:
said axis is formed in a conical shape, of which diameter is gradually decreasing in the squeezing direction; and
said revolving spiral blade is wound around said axis evenly or unevenly; wherein:
the height at any portion of said blade is set at equal so that the tip portion of said blade forms a conical shape, of which diameter is gradually decreasing in the squeezing direction.

9. The axial-flow squeezing apparatus according to either one of claims 1, 2, 3 and 10, wherein:
said axis is formed in a columnar shape;
said revolving spiral blade is wound around said axis evenly or unevenly; and
the height at any portion of said blade is set equal so that tip portion of said blade is formed in a cylindrical shape.

10. An axial-flow squeezing apparatus for continuous solid-liquid separation of objects to be squeezed comprising:
a perforated outer element formed into a cylindrical or conical shape; and
a spirally formed revolving blade around an axis comprising a spiral base of said blade, a spiral surface and spiral boundaries formed between said spiral base and said spiral surface; wherein:
almost all of said axis except starting portion of the squeezing is bored cylindrically up to a desired position;
cutouts are formed so as to be communicated to said spiral surface and spiral boundaries;
an inner sleeve having one or not less than two communicating portions is inserted and fitted in said cylindrical bore so that said communicating portions are arranged along said cutouts for forming bypath channels so as to enable to avoid clogging during squeezing operations.
